(19) United States
(12) Patent Application Publication
(10) Pub. No.: US 2008/0026721 A1
(43) Pub. Date: Jan. 31, 2008

(54) Method for making shell for electric product

(76) Inventor: Swei Mu Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/494,009

(22) Filed: Jul. 27, 2006

(51) Int. Cl. H04B 1/08; H04M 1/00

(52) U.S. Cl. 455/347; 455/575.1

(57) ABSTRACT

A method is used for manufacturing outer housings or shells for electric products or mobile communication devices and includes a base layer and a cover layer, an intermediate pattern layer is disposed and sandwiched between the base layer and the cover layer, and the intermediate pattern layer includes a pattern, the cover layer is made of transparent materials for allowing the pattern on the intermediate pattern layer to be seen through the cover layer, and a cushioning layer is attached to the base layer to form a housing member of a shell. An anti-static electricity material or natural fibers or wood chips or recycled or waste plastic materials or particles or electric conductive materials may be engaged into the cushioning layer.

### BACKGROUND OF THE INVENTION

1. Field of the Invention

The present invention relates to a shell manufacturing method, and more particularly to a method for making or manufacturing outer housings or shells for cushioning and protecting electric products, such as portable or mobile phones, personal digital assistants, electric games or game cards, electric mice, monitors, electric digital panels, portable computers, personal computers, or the like.

2. Description of the Prior Art

Typical electrical products or devices, such as portable or mobile phones, personal digital assistants, electric game cards, electric mice, monitors, electric digital panels, portable computers, personal computers, or the like comprise an outer housing or shell which is normally made of plastic materials and formed by such as molding or mold-injection processes, and for allowing the outer housings or shells to be manufactured in great speed and in mass production.

For example, U.S. Pat. No. 6,341,227 to Mooster et al. discloses one of the typical methods for manufacturing mobile communication devices, and also comprising one or more housing members that are normally manufactured or made of plastic materials and formed by such as molding or mold-injection processes.

U.S. Patent Application Publication No. US 2002/0085709 A1 to Hsu discloses another typical cover for mobile or portable phones, and also comprising one or more housing members that are normally manufactured or made of plastic materials and formed by such as molding or mold-injection processes, and comprising a number of catches for securing the housing members together.

However, the outer housings or shells are normally made of plastic materials which may not be used to suitably absorb or dissipate shocks and vibrations; i.e., the electric parts or elements received within the outer housings or shells may not be suitably cushioned or protected by the outer housings or shells.

The present invention has arisen to mitigate and/or obviate the afore-described disadvantages of the conventional methods for manufacturing outer housings or shells for electric products or mobile communication devices.

### SUMMARY OF THE INVENTION

The primary objective of the present invention is to provide a method for making or manufacturing outer housings or shells which may be provided or used for cushioning and protecting the electric products or mobile communication devices.

The other objective of the present invention is to provide a method for making or manufacturing outer housings or shells which may further include a pattern layer suitably sandwiched between an outer protective layer and an inner layer for preventing the pattern layer from being damaged.

The further objective of the present invention is to provide a method for making or manufacturing outer housings or shells which may further include anti-static electricity material or electric conductive materials engaged or embedded into the cushioning layer.

In accordance with one aspect of the invention, there is provided a method for manufacturing outer housings or shells for electric products or mobile communication devices, the method comprising providing a base layer and a cover layer, an intermediate pattern layer is disposed and sandwiched between the base layer and the cover layer, and the intermediate pattern layer includes a pattern, the cover layer is made of transparent materials for allowing the pattern on the intermediate pattern layer to be seen through the cover layer, and a cushioning layer is then attached to the base layer to form a housing member of a shell.

An anti-static electricity material and/or natural fibers and/or wood chips and/or recycled cut off materials or waste plastic materials or particles and/or electric conductive materials may be engaged into the cushioning layer.

Burrs may be removed from the housing member to form a smooth outer peripheral surface.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a portable or mobile phone to be manufactured with a method in accordance with the present invention, in which a portion of the portable or mobile phone has been cut off for showing an inner structure of the portable or mobile phone;

FIG. 2 is an enlarged partial perspective view of the portable or mobile phone;

FIG. 3 is an end view of the portable or mobile phone;

FIG. 4 is a perspective view illustrating a housing member of the portable or mobile phone;

FIG. 5 is a partial exploded view illustrating the materials for forming the housing member of the portable or mobile phone;

FIG. 6 is a cross sectional view illustrating the molding process for manufacturing the portable or mobile phone;

FIG. 7 is an enlarged partial cross sectional view illustrating the mold device as shown in FIG. 6;

FIG. 8 is a cross sectional view similar to FIG. 6, illustrating the other molding process for manufacturing the portable or mobile phone;

FIG. 9 is a cross sectional view similar to FIG. 8, illustrating the other molding process for manufacturing the portable or mobile phone;

FIG. 10 is a partial exploded and cross sectional view similar to FIGS. 8, 9 illustrating the further molding process for manufacturing the portable or mobile phone;

FIG. 11 is a cross sectional view illustrating the molding device as shown in FIG. 10;

FIG. 12 is a perspective view illustrating a camera to be made with the outer housing or shell manufactured with a method in accordance with the present invention, in which a portion of the camera has been cut off for showing an inner structure thereof;

FIG. 13 is a perspective view similar to FIG. 12, illustrating a monitor or portable computer to be made with the outer housing or shell manufactured with a method in accordance with the present invention; and

FIG. 14 is an enlarged partial perspective view of the portable computer, in which a portion of the portable computer has been cut off for showing an inner structure thereof.

### DETAILED DESCRIPTION OF THE PREFERRED EMBODIMENT

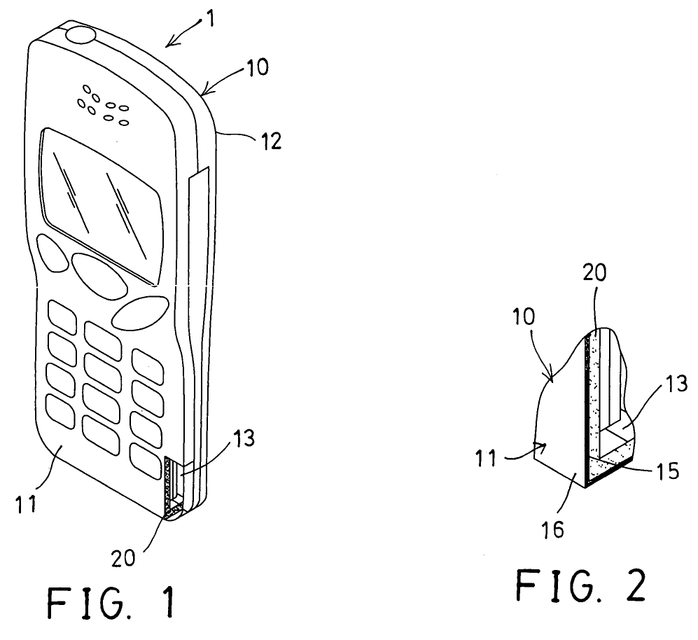

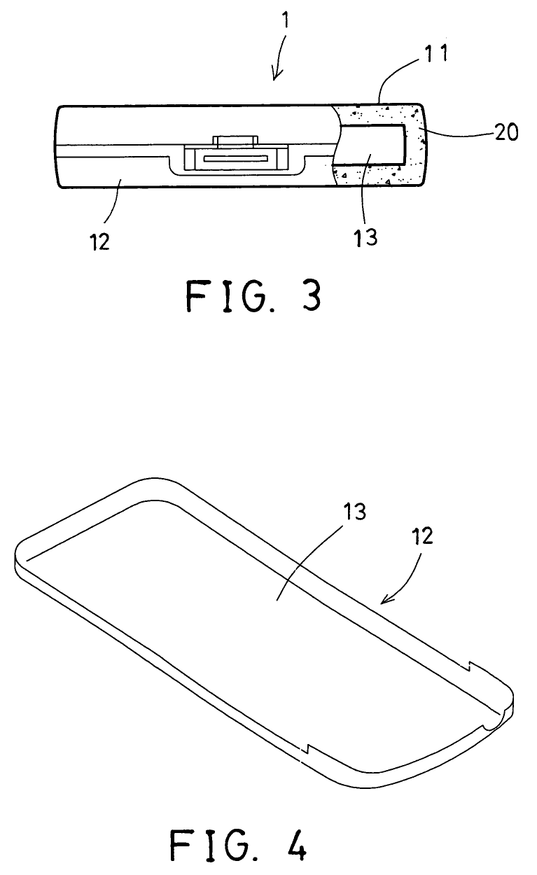

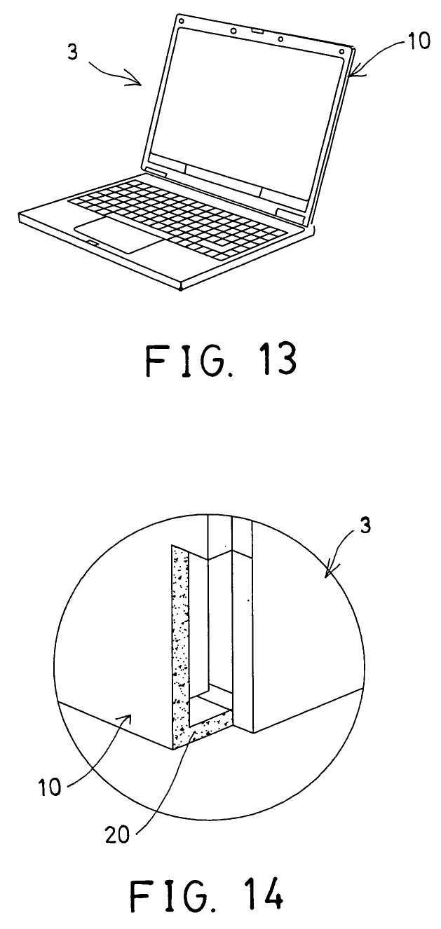

Referring to the drawings, and initially to FIGS. 1 and 2, a method in accordance with the present invention is provided for manufacturing an outer housing or shell 10 for various electric products 1, such as the portable or mobile phone 1 as shown in FIGS. 1-3, the camera facilities 2 as shown in FIG. 12, the monitors or portable computers 3 as shown in FIGS. 13-14, or the other electric products, such as personal digital assistants, electric games or game cards, electric mice, electric digital panels, personal computers (not shown), or the like.

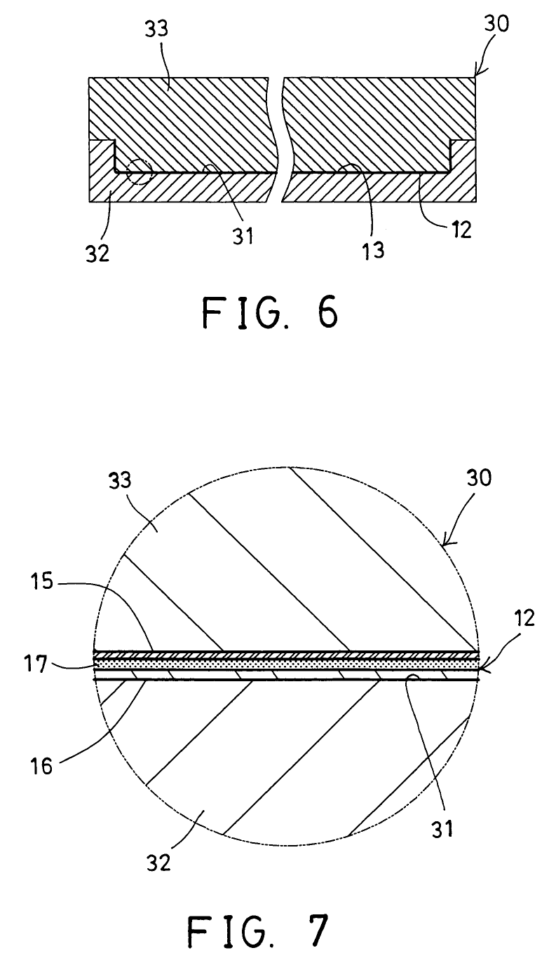

The shell 10 may comprise one or more housing members 11, 12 to be secured together with such as fasteners or latches (not shown), adhesive materials, or by welding processes, and each having a chamber 13 formed therein (FIGS. 1-4) for receiving various electric parts or elements therein (not shown). The housing members 11, 12 of the shell 10 each includes an inner or base layer 15 (FIGS. 5-7) preferably made of plastic or synthetic materials and formed by such as molding or mold-injection processes with a mold device 30 as shown in FIGS. 6-11, and each may include various colors or decorative patterns formed on the outer peripheral portion thereof (not shown).

The housing members 11, 12 of the shell 10 each further include an anti-corrosive and/or anti-abrasive outer or cover layer 16 provided on the outer peripheral portion thereof and/or attached onto the outer peripheral portion of the inner or base layer 15, best shown in FIGS. 5 and 7, and made of transparent or semi-transparent materials for allowing the colors or decorative patterns (not shown) formed on the outer peripheral portion of the inner or base layer 15 to be seen by the users or by people. The housing members 11, 12 of the shell 10 each further include an intermediate pattern film or membrane or layer 17 having various colors or decorative patterns 18 formed or provided thereon (FIG. 5) and disposed or sandwiched between the inner or base layer 15 and the outer or cover layer 16. The transparent or semi-transparent outer or cover layer 16 allows the colors or decorative patterns 18 formed or provided on the intermediate pattern film or membrane or layer 17 to be seen through the transparent or semi-transparent outer or cover layer 16.

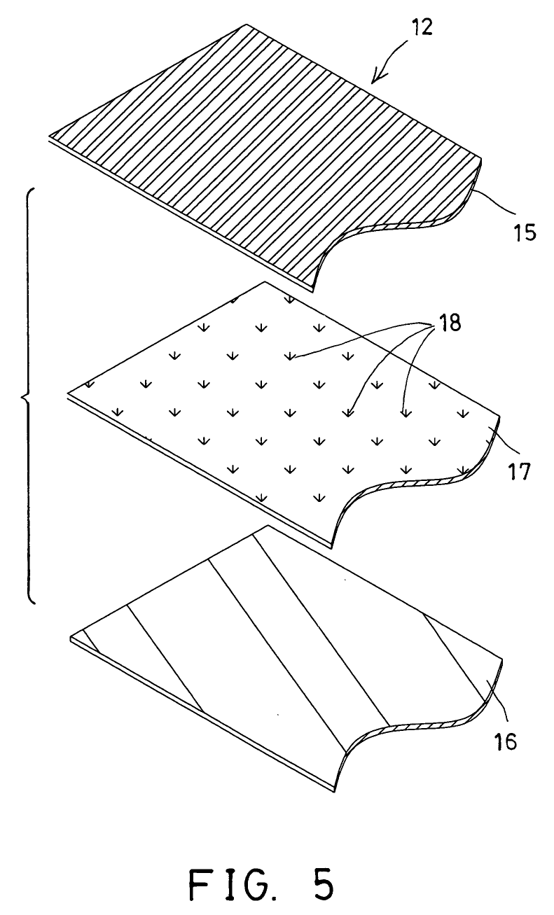

The outer or cover layer 16 and the intermediate pattern layer 17 may be attached or secured onto the inner or base layer 15 by the heat with such as the hot-pressing process or the molding or mold-injection processes. For example, as shown in FIGS. 6 and 7, the outer or cover layer 16 and the intermediate pattern layer 17 and the inner or base layer 15 may be disposed or engaged into a mold cavity 31 of the mold device 30 and clamped or hot-pressed or formed by such as a lower mold piece 32 and an upper mold piece 33 in order to solidly secure the outer or cover layer 16 and the intermediate pattern layer 17 and the inner or base layer 15 together and so as to mold or to form the housing members 11, 12 of the shell 10, in which each of the housing members 11, 12 includes the chamber 13 formed therein (FIG. 4).

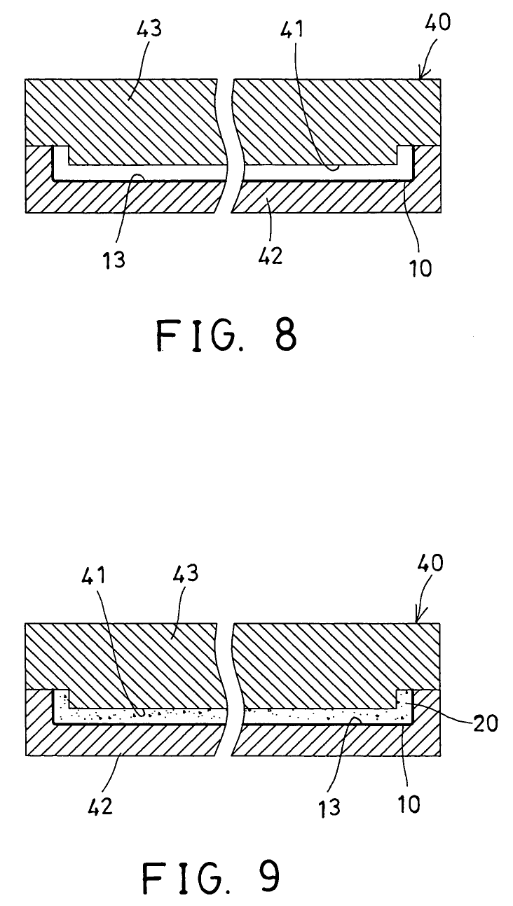

As shown in FIGS. 8 and 9, the molded housing members 11, 12 of the shell 10 may then be disposed or engaged into another mold device 40 which includes a mold cavity 41 formed therein and defined between such as a lower mold piece 42 and an upper mold piece 43. A foamable material or cushioning material or synthetic material may then be filled or introduced or injected into the mold cavity 41 of the mold device 40, in order to form a cushioning layer 20 in the inner peripheral portion of either or both of the housing members 11, 12 of the shell 10. The foamable material or cushioning material or synthetic material may include a suitable softness or resilience or the like for absorbing or dissipating the shocks and vibrations that may be applied to the housing members 11, 12 of the shell 10, and thus for suitably cushioning or protecting the electric parts or elements (not shown) received within the outer shell 10.

The foamable material or cushioning material or synthetic material may also attached or secured onto the housing members 11, 12 by the heat in such as the hot-pressing process or the molding or mold-injection processes. A trimming or finishing process may further be required or may be selectively provided to remove the burrs that may be formed on the outer peripheral portion of the formed or molded housing members 11, 12 of the shell 10, for forming a smooth and/or shiny outer peripheral surface or contour for the housing members 11, 12 of the shell 10. Each of the electric products 1-3 (FIGS. 1-3 and 12-14) may include two or more shells 10 that include different colors or decorative patterns formed or provided therein for allowing the shells 10 to be changed from each other.

It is to be noted that an additional leather or cloth layer (not shown) may further be provided and attached or secured onto either the inner portion or the outer portion of the housing members 11, 12 of the shell 10 during the molding processes for forming a different outer peripheral surface. Wood chips or natural fibers or other recycled cut off materials or waste plastic materials or particles, and/or anti-static electricity or electric conductive materials may further be provided and disposed or engaged or embedded into the foamable material or cushioning material or synthetic material for forming the cushioning layer 20 of the housing members 11, 12 of the shell 10.

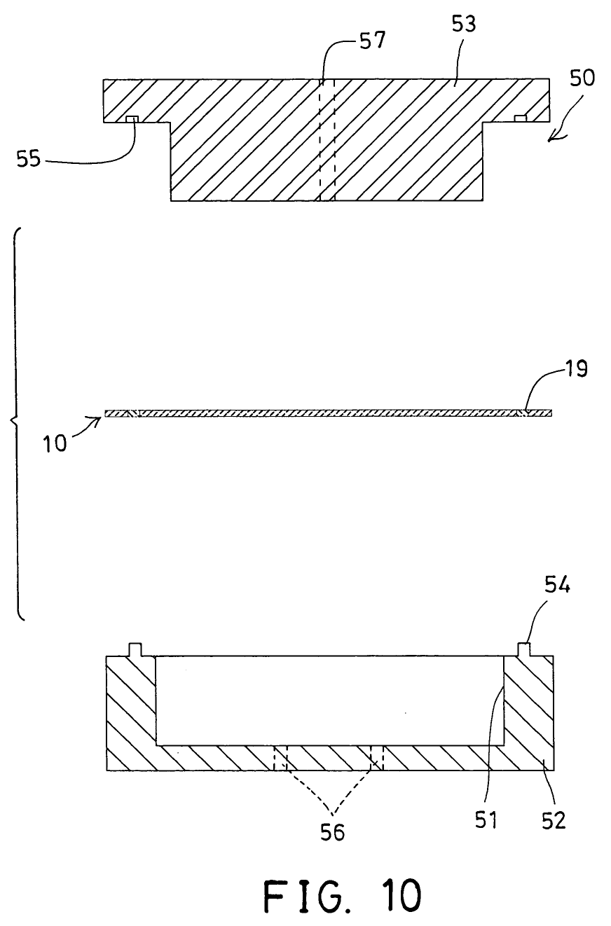

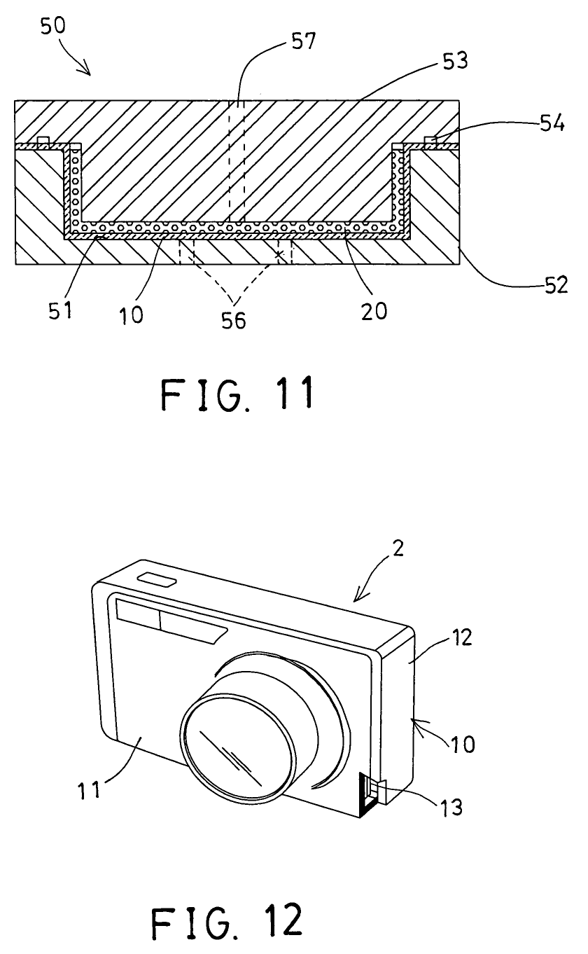

Alternatively, as shown in FIGS. 10-11, the outer or cover layer 16 and the intermediate pattern layer 17 and the inner or base layer 15 may be directly disposed or engaged into a mold cavity 51 of another mold device 50 that is formed or defined between such as a lower mold piece 52 and an upper mold piece 53, and vacuumed or sucked or drawn to closely engage with an inner surface of one of the mold pieces 52 with such as a vacuuming process. The upper or the lower mold piece 52 may include one or more projections 54 extended therefrom for engaging into the corresponding depressions 55 of the lower or upper mold piece 53 for anchoring the mold pieces 52, 53 together.

For example, one of the mold pieces 52 may include one or more ports 56 formed therein and coupled to a vacuuming source (not shown) for vacuuming and for drawing the outer or cover layer 16 and the intermediate pattern layer 17 and the inner or base layer 15 to closely engage with the inner surface of one of the mold pieces 52, in order to form a space within the mold device 50 or between the upper mold piece 53 and the outer or cover layer 16 and the intermediate pattern layer 17 and the inner or base layer 15 for the shell 10, and then for allowing the material to be filled or introduced or injected into the mold cavity 51 the mold device 50 via a passage 57 of the upper mold piece 53, for example, in order to directly form the housing members 11, 12 of the shell 10 that have the foamable or resilient cushioning layer 20 engaged or positioned or secured therein.

The outer or cover layer 16 and the intermediate pattern layer 17 and the inner or base layer 15 for the shell 10 may include one or more orifices 19 formed therein for receiving the projections 54 of the lower mold piece 52 and for suitably positioning or anchoring the outer or cover layer 16 and the intermediate pattern layer 17 and the inner or base layer 15 for the shell 10 within the mold cavity 51 the mold device 50 and for preventing the outer or cover layer 16 and the intermediate pattern layer 17 and the inner or base layer 15 for the shell 10 from being moved and randomly received within the mold cavity 51 the mold device 50.

In operation, as shown in FIGS. 1-3 and 12-14, the method in accordance with the present invention may be provided for making or manufacturing the housing members 11, 12 of the shell 10 for the various electric products 1, 2, 3, and for providing the foamable or resilient cushioning layer 20 to cushion and protect the various electric parts or elements (not shown) received in the electric products 1, 2, 3. In addition, the provision and the engagement of the intermediate pattern film or membrane or layer 17 between the inner or base layer 15 and the outer or cover layer 16 allow the various colors or decorative patterns 18 provided on the intermediate pattern film or membrane or layer 17 to be suitably disposed and sandwiched and protected between the inner or base layer 15 and the outer or cover layer 16 and to prevent the colors or decorative patterns 18 from being dispersed.

Accordingly, the method in accordance with the present invention may be provided for making or manufacturing outer housings or shells which may be provided or used for cushioning and protecting the electric products or mobile communication devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for manufacturing outer housings for electric products or mobile communication devices, said method comprising:
providing a base layer and a cover layer,
disposing and sandwiching an intermediate pattern layer between said base layer and said cover layer, said intermediate pattern layer including a pattern provided thereon and protected between said base layer and said cover layer, said cover layer being made of transparent materials for allowing the pattern on said intermediate pattern layer to be seen through said cover layer, and
attaching a cushioning layer to said base layer to form a housing member of a shell.

2. The method as claimed in claim 1 further comprising introducing anti-static electricity material into said cushioning layer.

3. The method as claimed in claim 1 further comprising introducing natural fibers into said cushioning layer.

4. The method as claimed in claim 1 further comprising introducing electric conductive material into said cushioning layer.

5. The method as claimed in claim 1 further comprising removing burrs from said housing member to form a smooth outer peripheral surface.
